(19) United States
(12) Patent Application Publication
(10) Pub. No.: US 2010/0064232 A1
(43) Pub. Date: Mar. 11, 2010

(54) DEVICE, SYSTEM AND METHOD FOR PROVIDING CONTROLLED ONLINE COMMUNICATION

(76) Inventors: Adi Brandwine, Ramat Hasharon (IL); Shay Bloch, Rishon LeZion (IL)

Correspondence Address: Pearl Cohen Zedek Latzer, LLP, 1500 Broadway, 12th Floor, New York, NY, 10036, US

(21) Appl. No.: 12/205,206

(22) Filed: Sep. 5, 2008

(51) Int. Cl. G06F 3/00

(52) U.S. Cl. 715/760

(57) ABSTRACT

A device, system and method is presented for providing controlled online communication. A web server may download a set of pre-approved input from a separate server. A security user input field may be activated. The web server may check the content of the data entered into the security user input field. The web server may embed the entered data into the web page user input field if and only if the data is verified to be within the set of pre-approved input. The web server may then receive the embedded data for altering the web page.

### BACKGROUND OF THE INVENTION

Parental control software provides protection against user exposure to undesirable behavior in computer environments where human intervention is impractical. The software typically blocks the use of expletives or other undesirable words or phrases in online chatting communities.

However, even with the exclusion of expletives and selected words or phrases, a user may still communicate undesirable behavior through other means. For example, a user may use subtle implications or inflections of their words to convey thoughts other than what is literally stated. In one test of Knowledge Adventures (KA) parental control software which limits language to the use of “harmless words”, a 14-year-old boy, within minutes of operation, developed a vulgar phrase using animals as metaphors for sexually explicit subject matter.

To solve this problem, parental control software has been developed that restricts users to a list of pre-arranged statements and conversations. The pre-arranged statements typically exclude undesirable words that are fixedly arranged to avoid alternate word constructions that may be construed as vulgar. In one example, the user is first prompted to select a subject or topic in general for discussion and is then provided with a list of sentences from which they can select a sentence to communicate. The user cannot simply type what he/she wants to communicate, but instead must navigate a search engine to find the pre-arranged statement that is the closest match thereto. The communications are rigid and lack variation in tone, inflection, and composition, or other properties that are crucial to sincere human communication.

A need exists to protect users against exposure to undesirable behavior that does not stifle the creative variations in human communication.

### SUMMARY OF THE INVENTION

In an embodiment of the invention, a method for providing controlled online communication may include downloading, in a web server, a set of pre-approved input, from a separate server. The method may further activate a security user input field adapted for checking the content of the data entered therein. The method may embed the entered data into the web page user input field if and only if the data is verified to be within the set of pre-approved input. The method may then receive the embedded data at the web server for altering the web page.

In an embodiment of the invention, a device for providing controlled online communication may include a language server to store at least one set of pre-approved language. The system may further include a web server, different from the language server. The web server may provide a web page having a user input field adapted for altering the web page. The web server may download a set of pre-approved input from the language server. The web server may disable the user input field. The web server may then activate a security user input field adapted for checking the content of the data entered therein. The web server may embed the entered data into the web page user input field if and only if the data is verified to be within the set of pre-approved input. The web server may then receive the embedded data for altering the web page.

In an embodiment of the invention, a user interface for providing controlled online communication may include a security field provided by a web server and adapted to display text and other data entered into an input device of a computer. The entered data may be compared, e.g., by the web server, to a set of pre-approved input downloaded from a remote server. If the data entered into the input device is excluded from the set of pre-approved input, the data entered may be blocked from being displayed in the security field.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for providing controlled and secure online communication according to an embodiment of the invention;

FIGS. 2A and 2B are flowcharts of a method according to an embodiment of the invention; and

FIGS. 3 and 4 are schematic illustrations of the security user input field of FIG. 1 according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

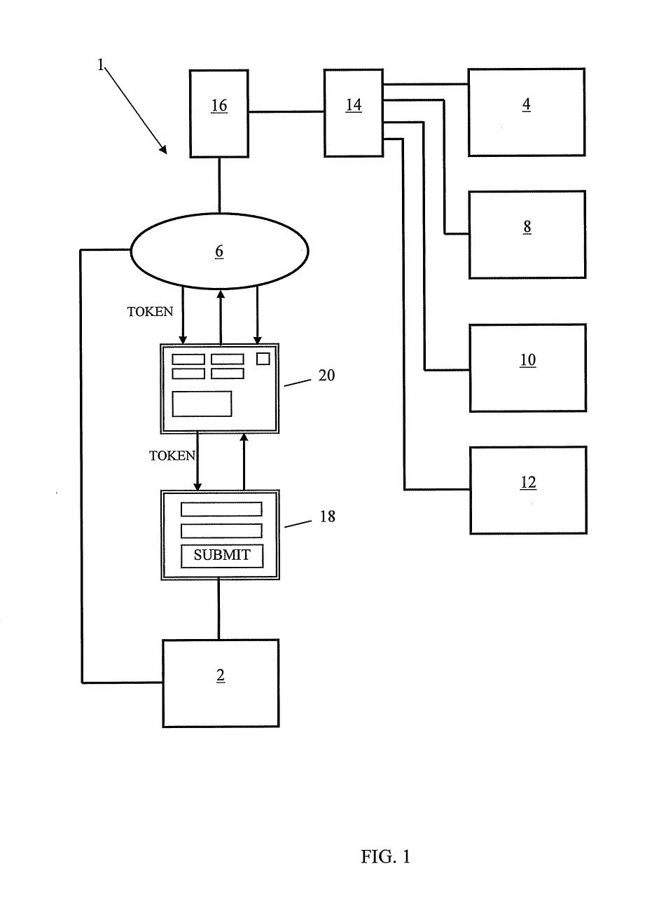

Reference is made to FIG. 1, which schematically illustrates a system 1 for providing controlled and secure online communication according to an embodiment of the invention. System 1 may include a computer 2, a language server 8, a database 10, and a remoting application server 12, each in operative communication with a web server 4 via a network 6, e.g., the Internet. System 1 may further include a load balancer 14 and/or a firewall 16.

Web server 4 may be adapted to provide a web page that may be viewed on a user interface of a display on computer 2.

Computer 2 may have a primary operating system, loadable or installed otherwise, for performing typical machine-wide functionality, e.g., operating a program for accessing an Internet web page via web server 4 and operating a program for supporting text and graphics files provided by the web page.

Web server 4 may be adapted to provide a web page having a user input field 18 adapted to submit user data to web server 4. In one example, the web page may provide an online environment for communicating via network 6, such as an online chat room, a web log (blog), an email page, an online learning or gaming environment, etc. Web page user input field 18 may be adapted to alter a web page, for example, by posting the entered data (e.g., in a blog) or sending the entered data (e.g., in an email) where the data may be accessible to another user. In another example, the web page may provide a search engine. Web page user input field 18 may be adapted to alter a web page, for example, by changing web pages to display the web page most closely matching the search terms. Embodiments of the invention may prevent a user from entering undesirable language into web page user input field 18. In the aforementioned first example, the entry of the undesirable language may be blocked to prevent the broadcast thereof to an online community. In the aforementioned second example, the entry of the undesirable language may be blocked to prevent a search engine from retrieving a web page that matches the undesirable language.

Web server 4 may provide a security user input field 20. Security user input field 20 may be activated in response to a user attempt to input data into web page user input field 18, e.g., before data is actually entered. The attempt to enter data may include clicking on or selecting the web page user input field with a keyboard, mouse, or other known input device of a computer. The triggered events may be, e.g., “onClick” or “onFocus” events, which are known. Security user input field 20 may be overlaid on, blocking, adjacent to, etc., web page user input field 18. Web page user input field 18 may be defined by code, e.g., formatted in a markup language, such as a hypertext markup language (HTML). Security user input field 20 may be an Adobe® Flash® object. Alternatively, other languages, graphics, or programs may be used.

Since data entered into web page user input field 18 may be adapted to alter a web page (e.g., posted on an internet site), to ensure secure and controlled online communication, security user input field 20 may be used to receive data for checking its content. The data entered via security user input field 20 may be verified, e.g. in the web server 4 to be within a set of pre-approved input by blocking entry of content that is excluded from the set. The set of pre-approved input may include a dictionary or set of words, phrases, rules of composition and usage, etc., which are pre-approved, e.g., for online communication.

When a user attempts to enter data excluded from the set of pre-approved input, the input pathway (e.g., cursor, mouse, keyboard, etc.) may be blocked or the entry may be automatically discarded. Thus, a user may freely type and may only be interrupted when input is or is predicted to be outside of the set of pre-approved input. In one embodiment, when a user attempts to enter text excluded from the set of pre-approved input, security user input field 20 may block only the excluded text. The user may freely continue to type and may return to correct the blocked entry at a later time. The blocked entry may be highlighted by a marker or a flag so the user may scan the message and easily identify and correct the blocked entries. In another embodiment, security user input field 20 may block the input pathway entirely. For example, a key and number lock on a keyboard or mouse lock may be activated. For example, no entry via an input device may be accepted until text excluded from the set of pre-approved input is removed. Security user input field 20 may activate an alert indicating that the input pathway is blocked. For example, a sound may be transmitted by computer 2 (e.g., using speakers) each time a user clicks on security user input field 20 with a mouse or keyboard.

Web server 4 may provide the user with predicted results that are within the set of pre-approved word. The user may select to insert one of the predicted results, e.g., by clicking on the desired term within the suggested terms with a mouse.

Once web server 4 verifies that the data entered into security user input field 20 is within the set of pre-approved input, computer 2 (e.g., using an antenna or other transmitter or other communication means) may automatically send the data embedded into web page user input field 18 to web server 4. Web server 4 may receive the transmitted data (e.g., using an antenna or other receiver) and may broadcast the data to an online community.

Web server 4 may have a plurality of ports for connecting with other devices in system 1 (not shown). Web server 4 may connect with computer 2 using one of the plurality of ports, e.g., a default port 80, which is known. The connection between computer 2 and web server 4 (e.g., via port 80) may be considered “insecure”. For example, a third party may intervene, alter, or corrupt data transmitted over network 6 between computer 2 and web server 4. Techniques such as “sniffing” identifies specific communications transmitted to and from computer 2, e.g., by analyzing data sent and received from a specific network card.

To prevent the alteration of the set of pre-approved input, e.g., by an online assailant, the set must be secured. Since web server 4 may be insecure, the set of pre-approved input may be stored in language server 8. Language server 8 may be located remotely from web server 4. In an alternative embodiment (not shown), language server 8 may be located local, connected, or integral to web server 4, e.g., as part of a single server. In such an embodiment, the content of language server 8 may generally withheld from web server 4 and only available to the web server 4 via a secure connection. Web server 4 may only access the set of pre-approved input from language server 8 via a “secure” port (e.g., port 9339). The secure port may operate using a security protocol that may encrypt and decrypt data only between the two network devices, protecting them against third party tampering. The identity of a remote client may be validated, for example, using a point-to-point protocol (PPP) server (not shown). A remote client may request a random key from the PPP server. The PPP server may send the remote client a key that is valid session-wide. When the client sends the PPP server an encoded password and key, the PPP server verifies if the hash is valid and send the remote client a response.

For example, language server 8 may open a secure pipeline to directly send data from language server 8 to web server 4. Language server 8 may only communicate with web server 4, for example, once the identity of web server 4 has been verified. The communication cannot be interrupted by a third party and typically continues until the data transfer has been completed.

Once data entered into security user input field 20 is verified and embedded into web page user input field 18, computer 2 may transmit the embedded data to web server 4 via a potentially insecure port (e.g., port 80). Remoting application server 12 may encrypt the data embedded into web page user input field 18 to ensure the data may be securely sent from computer 2 to web server 4. In one embodiment, remoting application server 12 may generate a code, e.g., a unique encrypted key or token, corresponding to the embedded data. When web server 4 receives the embedded data, web server 4 may likewise generate a code corresponding to the received data using the same algorithm as used by remoting application server 12. If the two codes match, web server 4 may further verify that the received data is the same as the embedded data. Since the content of the embedded data is verified to be within the set of pre-approved input, the content of the received data is likewise within the set of pre-approved input. Therefore, web server 4 may broadcast the received data in a controlled and secure online environment. Remoting application server 12 may include, e.g., a dynamic link library (DLL) in C+ or another programming language.

Database 10 may store input and/or results associated with computer 2, e.g., user input, session keys, codes, or other user or session data. Database 10 may include, e.g., a structured query language (SQL) server (not shown).

Load balancer 14 may mediate traffic flow from computer 2 and/or other computer(s) (not shown) to web server 4.

Firewall 16 may control signals between computer 2 and web server 4 by directing signals to the appropriate port (e.g., port 80), in order to optimize network resources.

Although a single web server 4 is described to provide both a web page and security user input field 20 embedded therein, it may be appreciated that in other embodiments of the invention web server 4 may provide a web page and a separate security server may provide security user input field 20. Security user input field 20 may be embedded into the web page as a graphical user interface (GUI) widget. Accordingly, security user input field 20 may be integrated into any web page having web page user input field 18 to control the entry of data therein.

Although a single computer 2 is shown in FIG. 1, it may be appreciated that one or more additional computer(s) (not shown) may be used to communicate with computer 2. To provide a secured and controlled environment, each additional computer may be subject to the same standards and processes as is described in reference to computer 2.

Furthermore, although a single web server 4 is described to provide a web page, a plurality of web servers (not shown) may be used. For example, each one of the plurality of web servers may provide a portion or feature of the web page. Furthermore, web server 4, remoting application server 12, and/or database 10 may be combined as one or more servers.

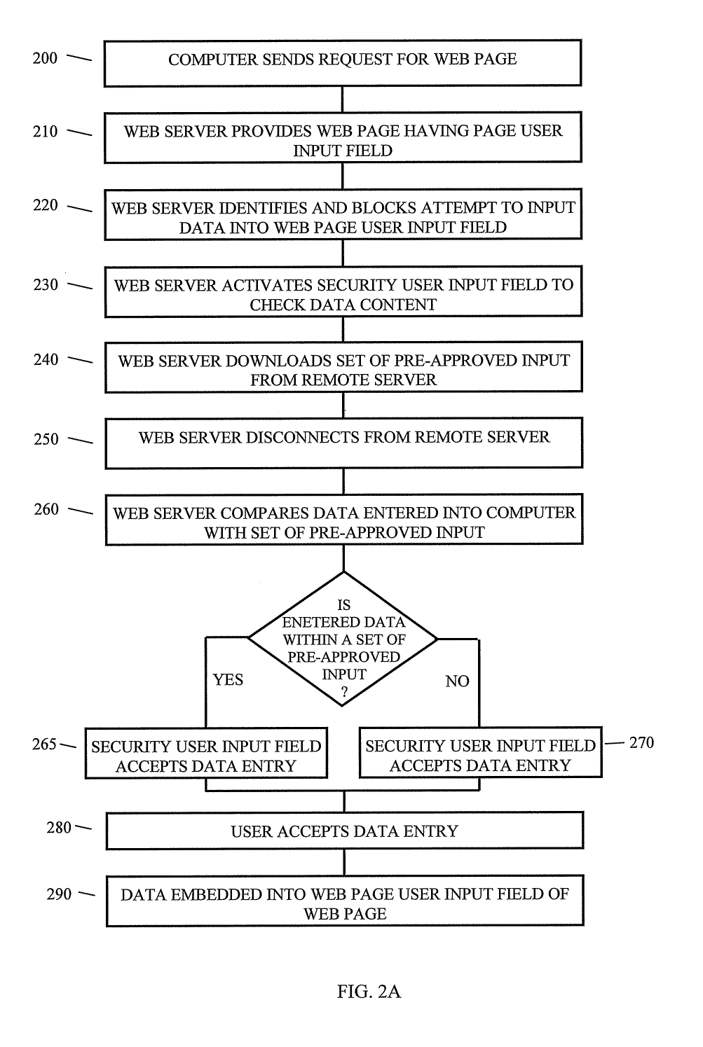

Reference is made to FIGS. 2A and 2B, which are flowcharts of a method according to an embodiment of the invention. The method described in the figure may describe the interactions of components of system 1 of FIG. 1.

In operation 200, a computer (e.g., computer 2 of FIG. 1) may accept a network destination address of a web page and send a request to retrieve the web page from the appropriate web server.

In operation 210, a web server (e.g., web server 4 of FIG. 1) may provide the computer with a web page having a web page user input field (e.g., web page user input field 18 of FIG. 1). The computer may automatically download the text and/or graphics from the web server associated with the web page. In one example, the web page may be a communication portal to an online community.

The web page user input field may be part of the web page. Each data in the web page user input field may be designated by a unique value stored in the code of the web page in the web server. When data entered (e.g., embedded) into the web page user input field (e.g., operation 290) is received by the web server (e.g., operation 360), the web server may change or update the value for altering a web page. Altering a web page may include, e.g., editing the content of the web page by altering the code thereof, redirecting to change to a different web page by inputting a web address or code in the field, etc.

In operation 220, the web server may detect an attempt to input data into the web page user input field. The web page user input field may provide information from the computer to the web server via an insecure connection (e.g., port 80). In order to control the communication environment provided by the web page, the web server may block the entry of data into the insecure web page user input field of the web page.

In response to identifying an attempt to input data in the web page user input field, a process may proceed to operation 230. The attempt to enter data may include clicking on or selecting the web page user input field with a keyboard, mouse, or other known input device of the computer. The triggered events may be, e.g., “onClick” or “onFocus” events, which are known.

In operation 230, the web server may provide an alternate security user input field (e.g., alternate security user input field 20 of FIG. 1) to intermittently accept user input, in place of the blocked web page user input field. The security user input field may be an interim field into which data may be entered before the content thereof is verified.

The security user input field may be independent of the web page. Input in the security user input field typically does not alter the code of the web page. The security user input field may be adapted for checking whether or not input entered therein is included in the set of pre-approved input downloaded from the language server. Although input entered into the security user input field typically does not directly alter web page code for changing the web page, once the input is verified, the input may be embedded in the web page user input field, which in turn may be used to change the web page.

In one embodiment, the security user input field may be seamlessly overlaid on or embedded in the web page user input field of the web page provided in operation 210. The security user input field may be a transparent or translucent graphic shield or window, which may prevent the entry of data into the web page user input field underneath, but may be significantly indiscernible therefrom. In another embodiment, the security user input field may be visibly different from the web page user input field. For example, the security user input field may appear as a “pop-up” window, e.g., activated as an “onClick” event when a user clicks on the web page user input field. In another example, when the security user input field appears, the web page user input field and/or the web page formed thereonto may be visibly darkened, reduced in size, minimized, or otherwise diminished. Alternatively, the security user input field may be visibly brighter, larger in size, or otherwise highlighted, as compared with the web page user input field. Other visual presentations, graphics, and juxtapositions may be used as are known in the art.

In operation 240, the web server may download the content of a remote language server (e.g., language server 8 of FIG. 1). The content may include a set of pre-approved input, such as, words, phrases, rules of composition and usage, etc., which are pre-approved for online communication. The language server may connect to the web server via a secure connection (e.g., port 9339) so that the content of the language server, which may be pre-approved for online communication, cannot be altered or otherwise corrupted. The set of pre-approved input may be loaded into and stored in a secure memory location (e.g., random access memory (RAM)) of the web server. The secure memory location may be inaccessible to any outside source. The set of pre-approved input may be destroyed or erased from the secure memory location after a period of time or at the end of an online session of the computer or a predetermined number of communications therefrom.

Although a single set of pre-approved input is described in reference to the figures, it may be appreciated that, in an alternate embodiment, a plurality of different sets of pre-approved input may be used and stored in the language server. The plurality of different sets of pre-approved input may, for example, provide a variety of degrees of censorship for accommodating variations in, e.g., cultures, languages, age groups, subject matters, etc. Each of the plurality of sets of pre-approved input may differ by at least a single word. A pre-designated user verifying a password may set a level of security on a security web page, triggered by operation 230. If the level of security is set prior to operation 240, only the one set corresponding to that level of security, out of the plurality of pre-approved input sets, may be downloaded in operation 240.

It may be appreciated that although operations 230 and 240 are presented in sequence, the order thereof may be reversed or that the operations may be executed consecutively or in partially overlapping time periods.

In operation 250, after the content of the remote language server is downloaded, the web server may disconnect from the language server.

In operation 260, the web server may compare data entered into a computer input device with the set of pre-approved input.

If the web server determines that the data entered into the input device is included in the set of pre-approved input, a process may proceed to operation 265.

If the web server determines that the data entered into the input device is excluded from the set of pre-approved input, a process may proceed to operation 270.

In operation 265, the web server may enter the data entered into the input device into the security user input field. In one embodiment, when a user enters input but has not yet verified the completion thereof, the web server may provide, e.g., in an adjacent window to the security user input field, a plurality of options from which the user may select for completing the input. The options may be consistent with the input entered by the user and also in the set of pre-approved input. The options may be generated by predictive text mechanisms, which are known.

In operation 270, the web server may block the data entered into the input device from entry into the security user input field. In one embodiment, when a user enters input predicted to result in an entry that is excluded from the set of pre-approved input, an input pathway or device may be disabled. For example, the user cannot type letters or rearrange words into the security user input field that are predicted to result in the entry of data that is excluded from the set of pre-approved input. The prediction may be achieved using predictive logic, which is known, that may be located in the web server.

In one embodiment, the web page sounds a visual and/or auditory alert when such an entry is attempted. In another embodiment, an online session may be terminated if the user attempts to enter data excluded from the set of pre-approved input more that a predetermined number of times and/or of a certain type determined to be intentionally subversive.

In operation 280, the computer may receive a signal via an input device that the data in the security user input field is accepted as final or complete by a user. For example, a field button reading “okay” may be clicked using an input device. Since the accepted data was able to be entered into the security user input field, the accepted data may be determined to be in the set of pre-approved input.

In operation 290, the web server embeds the data accepted in operation 280 into the web page user input field of the web page provided in operation 210. The text may be visible to the user, but is typically unalterable. Any attempt to alter the data embedded into the web page user input field will prompt operation 230 to repeat, e.g., by “onClick” events, the validation of the changes according to the operations described herein. Accordingly, non-approved words may not be directly entered into the web page.

Communication from the computer to the web-page (e.g., via port 80) may be insecure. Accordingly, there is a need to prevent a third party program from changing the text embedded in the web page. In order to prevent the alteration of text by a third party program, a process may proceed to operation 300.

In operation 300, the web server may transmit the data in the security user input field to be received by a remoting application server (e.g., the remoting application server 12 of FIG. 1).

In operation 310, the remoting application server may generate a code, e.g., a unique encrypted key or token, corresponding to the received data. The code may be generated, for example, using a secure hash algorithm (SHA), such as SHA-1, which is known.

In operation 320, the web server may also embed the code corresponding to the embedded data into the web page. The code may be invisible and unalterable.

In operation 330, the computer may transmit the pre-approved input data embedded in operation 290 and the code corresponding thereto embedded in operation 320 to the web server.

In operation 340, the web server may generate a new code corresponding to the embedded input data using the same algorithm that the remoting application server used to generate the code in operation 310.

In operation 350, the web server may determine if the code generated in operation 310 matches the code generated in operation 340.

If the codes match, the web server may determine that the data verified as included in the set of pre-approved input and accepted by the user has not been corrupted (e.g., by a third party program). In this case, the process may proceed to operation 360.

However, if the codes do not match, the web server may determine that the data, since being verified, has been corrupted. In this case, the process may proceed to operation 370.

In operation 360, the web server may transmit the embedded data over a network (e.g., network 6 of FIG. 1), e.g., as a communication to an online community.

In operation 370, the web server may discard the data embedded into the web page and no communication may be transmitted to the online community.

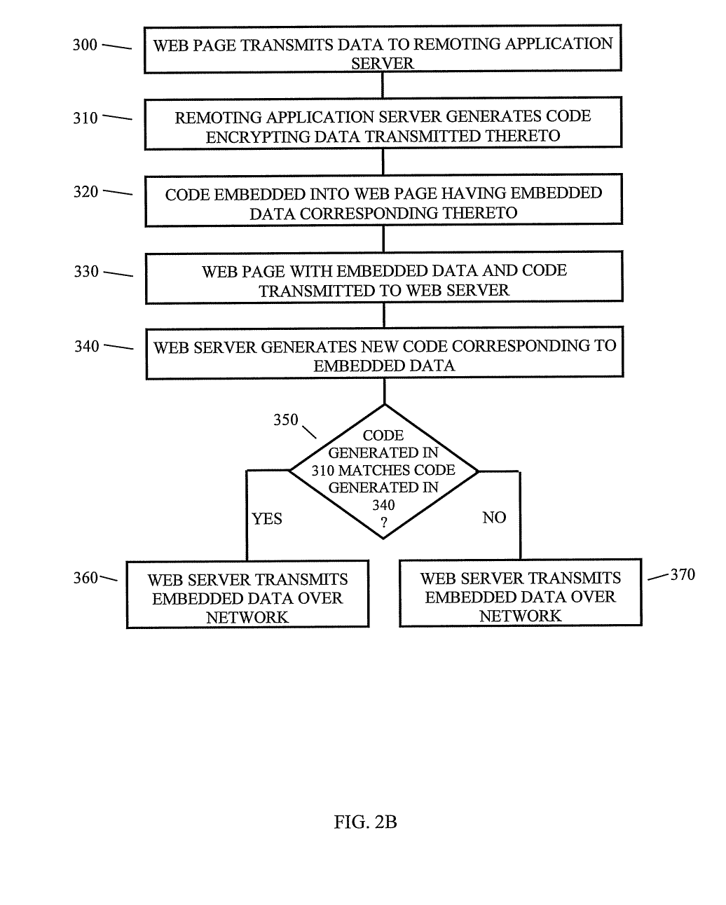

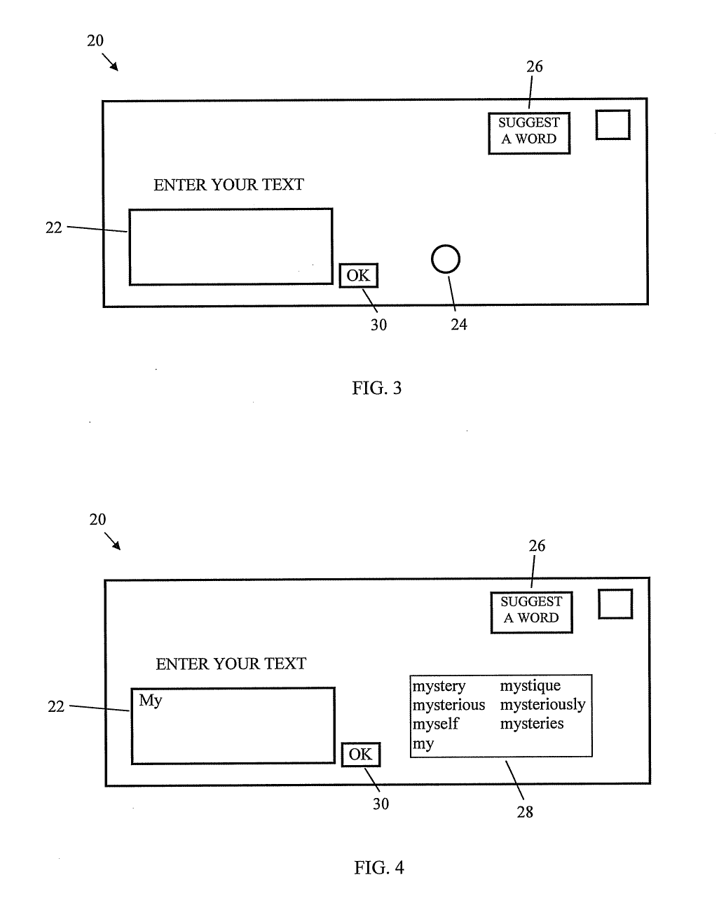

Reference is made to FIGS. 3 and 4, which schematically illustrate secure user input field 20 of FIG. 1 adapted for checking the content of data according to an embodiment of the invention. Secure user input field 20 may operate as a flash object, as shown in FIGS. 3 and 4. Alternatively, secure user input field 20 may be an HTML or other type of field (not shown).

Secure user input field 20 may be overlaid on or embedded in web page user input field 18 of the web page viewable on computer 2 of FIG. 1. Secure user input field 20 may include a prompt 24. Prompt 24 may indicate the status of web server 4 downloading the set of pre-approved input from language server 8 or the status of checking if input is in the set of pre-approved input. For example, the prompt 24 may display the word, “please wait”, “download complete”, or “verifying entry”, or may display a time or measurement icon, such as an hourglass or clock.

Secure user input field 20 may include a text box 22 for a user to freely type text using a keyboard or other input device. Secure user input field 20 may include a request field 26 to request from web server 4 elements of the set of pre-approved input that match the data already entered into text box 22. In reference to FIG. 4, a web server (e.g., web server 4 of FIG. 1) may use predictive logic to generate suggestions 28 of words or phrases that are pre-approved to complete an entry. In the example shown in FIG. 4, the letters “My” were entered. The resulting suggestions 28 include “mystery”, “mystique”, etc.

In reference to FIGS. 3 and 4, secure user input field 20 may include a submit field 30 to submit the input. When submit field 30 is activated (e.g., by clicking with a mouse), the data entered into text box 22 may be sent to a remote application server (e.g., remote application server 12 of FIG. 1) to generate a code for the encrypting data. In one example, the data may be sent using Flash® remoting, which is known. The code, together with the data entered into text box 22, are embedded into a web page user input field (e.g., web page user input field 18 of FIG. 1) and sent to the web server. The web server may create a new code for the received data and may compare the code with the embedded code to determine if the received data has been changed or otherwise corrupted since the data was embedded into the web page user input field. If the codes match, the data from which the codes were generated may be determined to match as well. Therefore, the web server may transmit the received data in a secure and controlled online environment.

Embodiments of the invention may be implemented in a network environment of any field or discipline. For example, embodiments of the invention may provide a safe environment for children, for users with special needs, conditions, or disabilities, such as, dyslexia, learning disabilities, hearing or visual impairments. In one example, when incomplete data is entered via a computer input device, security user input field 20 may automatically complete the entry with predicted words or phrases. The automated completion may, e.g., assist the blind. Alternatively, the automated completion may be used to supply amateur users with specialized terminology in a field, such as, the medical, legal, technical, and/or financial fields.

In one example, the web server may provide a medical reference web page. The language server may store sets of pre-approved words and phrases specific to the medical field. Security user input field 20 may restrict entry of input that is excluded from the special language set of the field stored in the language server. Alternatively, security user input field 20 may convert layman's terminology to specialized terminology or visa versa.

In another example, the web server may be a product page requesting financial information for completing an online transaction. In this example, the language server may be a bank server that securely stores account information. The web server may check if credit card numbers entered into security user input field 20 correspond to a valid account provided by the secure bank server. The web server may block the entry of any numbers into security user input field 20 that are not within a set of account information in the bank server. Alternatively or additionally, the security user input field 20 may restrict the type of data entered (e.g., letters vs. numbers), e.g., to comport with the requirements of the web page user input field. For example, if the web page requests a credit card number or date or birth, security user input field 20 may block entry of letters and only accept numerals.

Embodiments of the invention may be implemented in any computer language, including, but not limited to, C, C++, Java, BASIC, assembly languages, HTML, ActionScript, or any other language(s).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method, comprising:
disabling a web page user input field adapted for altering a web page provided by the web server;
downloading, in a web server, a set of pre-approved input, from a separate server; and
activating a security user input field to trigger a check of the content of the data entered into the security user input field;
embedding the entered data into the web page user input field if and only if the data is verified to be within the set of pre-approved input; and
receiving the embedded data in the web server for altering the web page.

2. The method of claim 1, wherein the step of activating a security user input field further comprises, as long as a user enters input but has not yet verified the completion thereof:
providing a plurality of input options from which the user may select for completing the input, wherein said plurality of input are consistent with the input entered and are included in said set of pre-approved input.

3. The method of claim 1, wherein when a user enters input predicted to result in an entry that is excluded from the set of pre-approved input, disabling the users input pathway.

4. The method of claim 3, further comprising providing an alert indicating that the input pathway is blocked.

5. The method of claim 1, further comprising transmitting with the embedded data a code corresponding thereto for verifying that the embedded data is securely transmitted.

6. The method of claim 1, further comprising storing in the separate server the set of pre-approved input.

7. The method of claim 1, further comprising storing in the separate server a plurality of sets of pre-approved input each differing from each other by at least one word, wherein the set of pre-approved input downloaded from the separate server is the one of the plurality of sets selected by a pre-designated user verifying a password.

8. The method of claim 1, wherein the set of pre-approved input comprises a list of words.

9. The method of claim 1, wherein the set of pre-approved input comprises combinations of words.

10. The method of claim 1, wherein the set of pre-approved input excludes expletives.

11. A device, comprising:
a first server to store a set of pre-approved language;
a second server, different from the first server, wherein the second server is to:
provide a web page having a user input field adapted for altering the web page;
download the set of pre-approved input from the first server;
disable the user input field;
activate a security user input field adapted for checking the content of the data to be entered therein;
embed the entered data into the web page user input field if and only if the data is verified to be within the set of pre-approved input; and
receive the embedded data for altering the web page.

12. The device of claim 11, wherein the second server comprises predictive logic to determine whether the data to be entered into the security user input field is in or is excluded from the set of pre-approved input.

13. The device of claim 11, wherein when the predictive logic determines that data to be entered into the security user input field is excluded from the set of pre-approved input, blocking the entry of the data into the security user input field.

14. The device of claim 13, wherein the second server is to provide an alert indicating that the entry of data into the security user input field is blocked.

15. The device of claim 11, wherein the second server is to further embed, with the embedded data, a code corresponding thereto, for verifying that the embedded data is securely transmitted.

16. The device of claim 11, wherein the second server further comprises a memory to store the set of pre-approved input downloaded from the first server.

17. A user interface, comprising:
a security field provided by a web server and adapted to display text entered into an input device of a computer, wherein the entered data is compared to a set of pre-approved input downloaded from a remote server, wherein if the data entered into the input device is excluded from the set of pre-approved input, the data entered is blocked from being displayed in the security field.

18. The user interface of claim 18, further comprising a prompt to indicate the status of the web server downloading the set of pre-approved input from the remote server.

19. The user interface of claim 18, further comprising suggestion fields including data that are predicted to complete the text entered into an input device and that are included in the set of pre-approved input.

20. The user interface of claim 18, further comprising an alert indicating that the entry of data from the input device into the security user input field is blocked.
